(19) United States
(12) Patent Application Publication
(10) Pub. No.: US 2017/0311388 A1
(43) Pub. Date: Oct. 26, 2017

(54) HEATING PAD

(71) Applicant: Wei Hsu, New Taipei City (TW)

(72) Inventor: Wei Hsu, New Taipei City (TW)

(21) Appl. No.: 15/133,241

(22) Filed: Apr. 20, 2016

(51) Int. Cl. H05B 3/36; H05B 3/18; H05B 1/02

(52) U.S. Cl. CPC H05B 3/36; H05B 1/0202; H05B 3/18

(57) ABSTRACT

A heating pad comprises a control box comprising an upper cover, a Universal Serial Bus (USB) control board, an Direct Current (DC) control board, a cord, a LED light source, a plurality of screw and a lower cover; an upper layer comprising an outer layer and an inner layer; a foam; a heating plate and a lower layer. The control box of the present invention is capable of adapting the current from the power source of Universal Serial Bus (USB), mobile power pack or regular Alternating Current (AC), that is, the Universal Serial Bus (USB) control board of the present invention can be connected to a Universal Serial Bus (USB) port of a computer or to a mobile power pack for power source, or, the Direct Current (DC) control board of the present invention can be connected to a regular Alternating Current (AC) power source for supplying power.

### BACKGROUND OF THE INVENTION

### Field of the Invention

The present invention relates to a heating pad, and more particularly to a heating pad which can be used with either a Universal Serial Bus (USB) power source or a regular Alternating Current (AC) source.

### The Prior Arts

Heating pad is wildly used in our daily life, it can be used in the product of clothes, comforter or blanket. The mechanism working behind the heating pad is transforming the electrical power to thermal energy to deliver the effect of heat preservation. A traditional heating pad is relatively simple, basically, it includes an electronic control board, a heating unit, an upper cover and lower cover and a power cord. The electronic control board is for power on/off and controlling the heating pad, and one end of the electronic control board is connected to the heating unit, another end is connected to power cord, and the upper cover and the lower cover wraps the electronic control board and the heating unit to become the final product of a heating pad. The power cord can be plugged into a regular Alternating Current (AC) source and the electronic control board will convert Alternating Current (AC) into Direct Current (DC) to make the heating unit to generate heat. However, as being wildly used in more and more occasions, the heating pad is often required to be used in a situation without a regular Alternating Current (AC) source. Therefore, how to use the heating pad in the environment without a regular Alternating Current (AC) source becomes a serious issue that needs a immediate solution.

In view of the above stated, the motivation of the present invention is to provide an heating pad which can be used with either a Universal Serial Bus (USB) power source or a regular Alternating Current (AC) source.

### SUMMARY OF THE INVENTION

The primary object of the present invention is to provide a heating pad which can be used with either a Universal Serial Bus (USB) power source or a regular Alternating Current (AC) source. The heating pad comprises a control box comprising an upper cover, a Universal Serial Bus (USB) control board, an Direct Current (DC) control board, a cord, a LED light source, a plurality of screw and a lower cover; an upper layer comprising an outer layer and an inner layer; a foam; a heating plate and a lower layer. The control box of the present invention is capable of adapting the current from the power source of Universal Serial Bus (USB), mobile power pack or regular Alternating Current (AC), that is, the Universal Serial Bus (USB) control board of the present invention can be connected to a Universal Serial Bus (USB) port of a computer or to a mobile power pack for power source, or, the Direct Current (DC) control board of the present invention can be connected to a regular Alternating Current (AC) power source for supplying power. The cord is connected to the heating plate. Either the Universal Serial Bus (USB) control board or the Direct Current (DC) control board is capable of adapting power of current and transmits it to the heating plate via the cord to make the heating plate to generate heat.

### BRIEF DESCRIPTION OF THE DRAWINGS

The related drawings in connection with the detailed descriptions of the present invention to be made later are described briefly as follows, in which:

FIG. 1 is a schematically perspective view of the heating pad according to the present invention.

FIG. 2A-2F are schematically perspective views of the assembly of the heating pad according to the present invention.

FIG. 3 is a schematically perspective view of the control box of the heating pad of the present invention.

FIG. 4 is a schematically perspective view illustrating the heating pad connecting to either the power source of a Universal Serial Bus (USB) or an Alternating Current (AC).

FIG. 5A-5B are schematically perspective views illustrating the assembly of an embodiment of the control box of the heating pad according to the present invention.

FIG. 6A-6B are schematically perspective views illustrating an dust-proof plug used with a Universal Serial Bus (USB) socket or an Direct Current (DC) socket according to the present invention.

### DETAILED DESCRIPTION OF THE PREFERRED EMBODIMENT

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

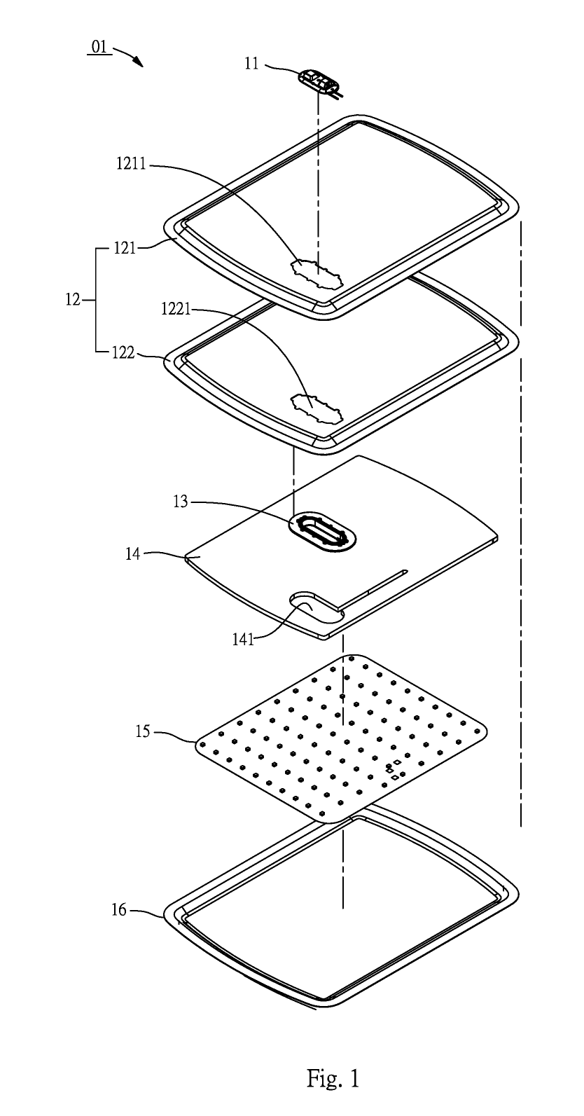

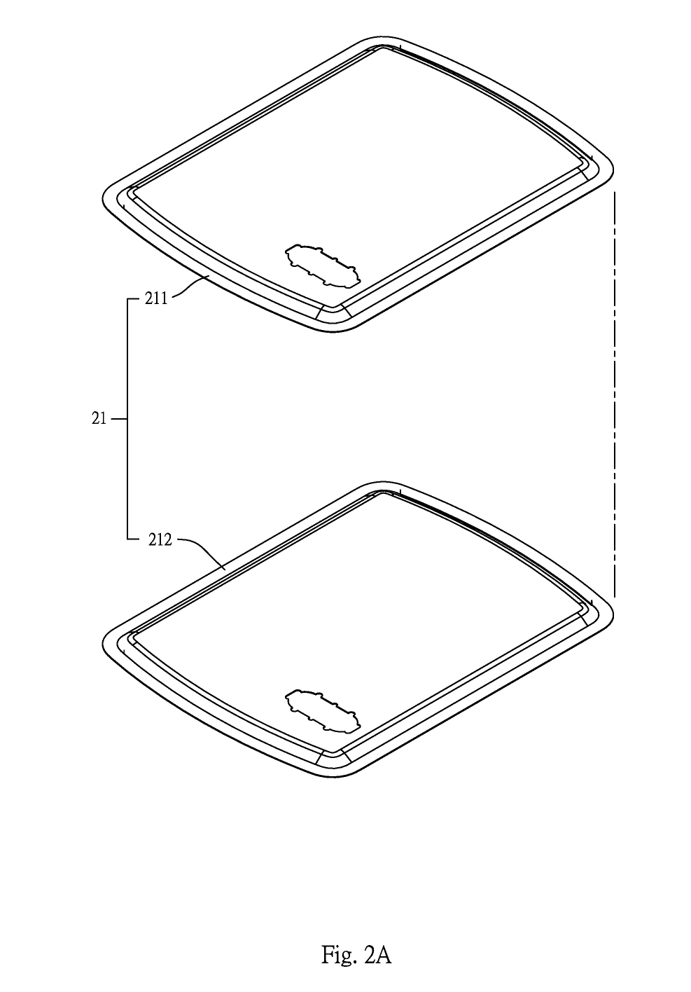

Please Refer to FIG. 1, FIG. 1 is a schematically perspective view of the heating pad according to the present invention. As shown in FIG. 1, the heating pad 10 according to the present invention comprises an upper cover 11 of a control box; an upper layer 12 comprising an outer layer 121 and an inner layer 122; an lower cover 13 of a control box; a foam 14; a heating pad 15 and an lower layer 16. The upper cover 11, the lower cover 13 and other elements can be assembled to become a control box whose details will be described later. An opening 1211 is disposed on the outer layer 121 and an opening 1221 is disposed on the inner layer 122. Through these openings, the upper cover 11 of the control box and the lower cover 13 of the control box are assembled. An opening 141 is disposed on the foam 14 to accommodate the lower cover 13 of the control box. The heating pad comprises a plurality of heating unit, and the heating unit can be chip-resistor. A plurality of chip-resistor can be welded together on a copper plate and the connection of each chip-resistor can be a combination of series and parallel way. Such combination of series and parallel connection is different than that in prior art in which it is either in series or parallel way. The combination of series and parallel connection of the chip-resistors assure the heating function of the heating pad of the present invention when partial chip-resistors are broken. More, the copper plate is capable of spreading the heat all over the whole heating pad efficiently and quickly, and is working as not only an electrical circuit but also a thermal conductor.

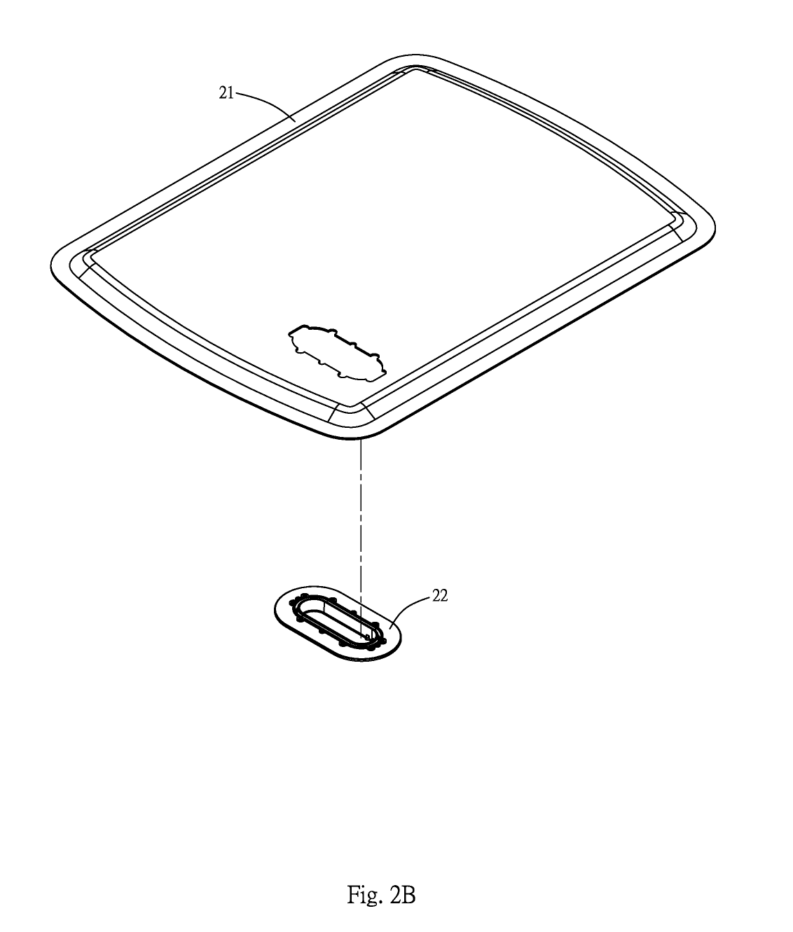

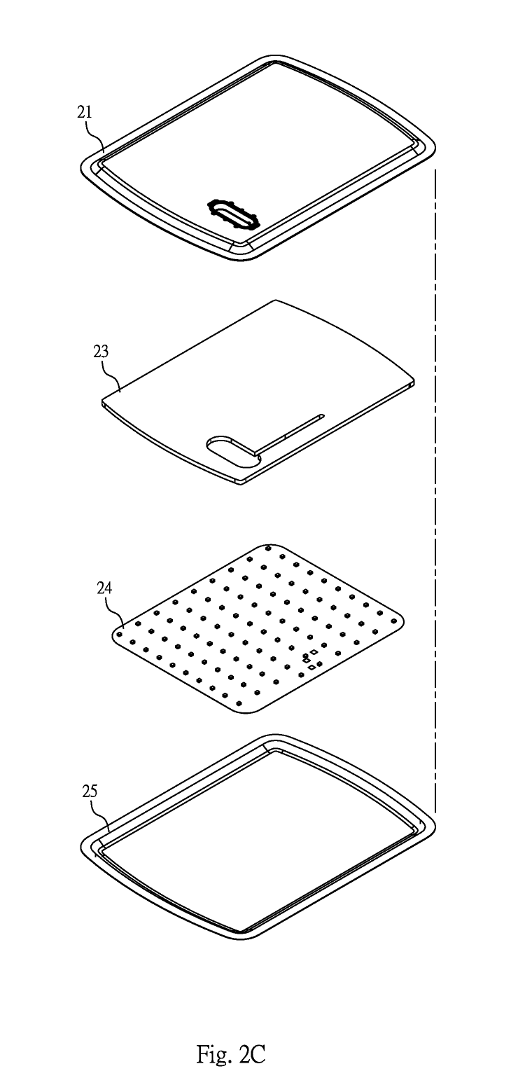

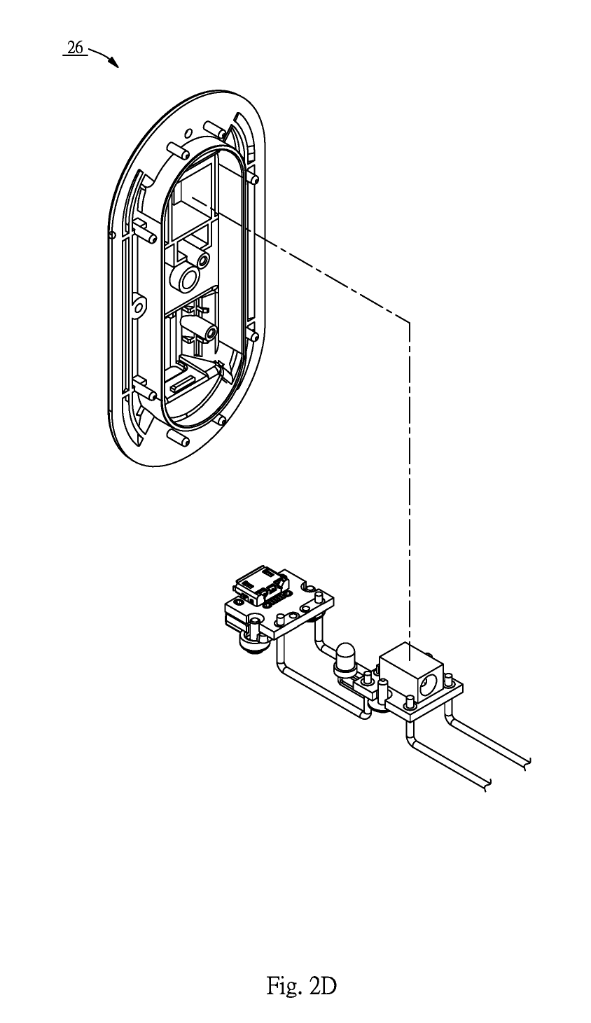

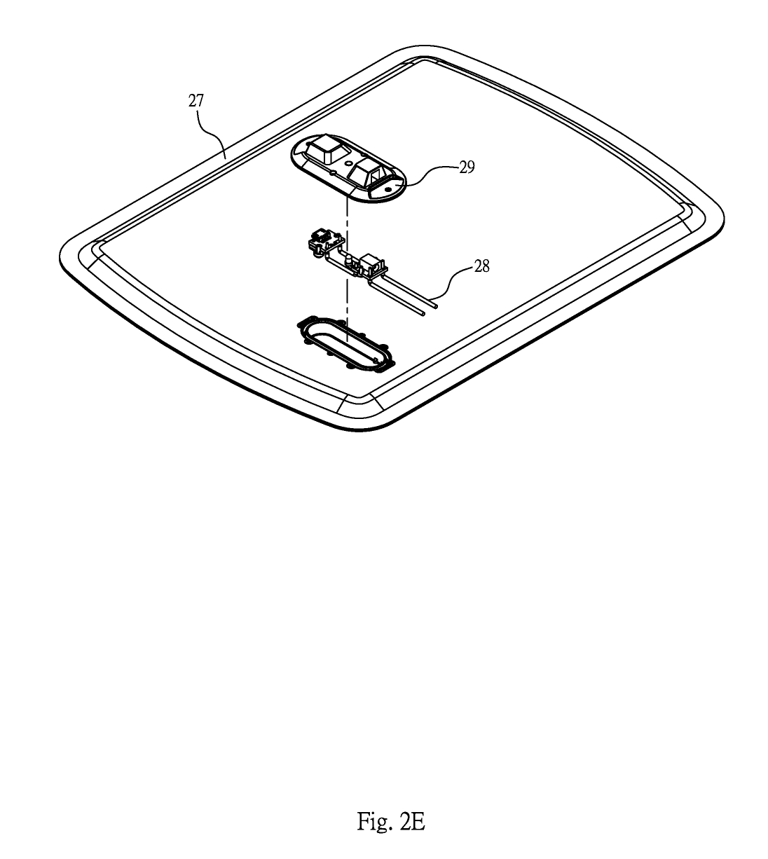

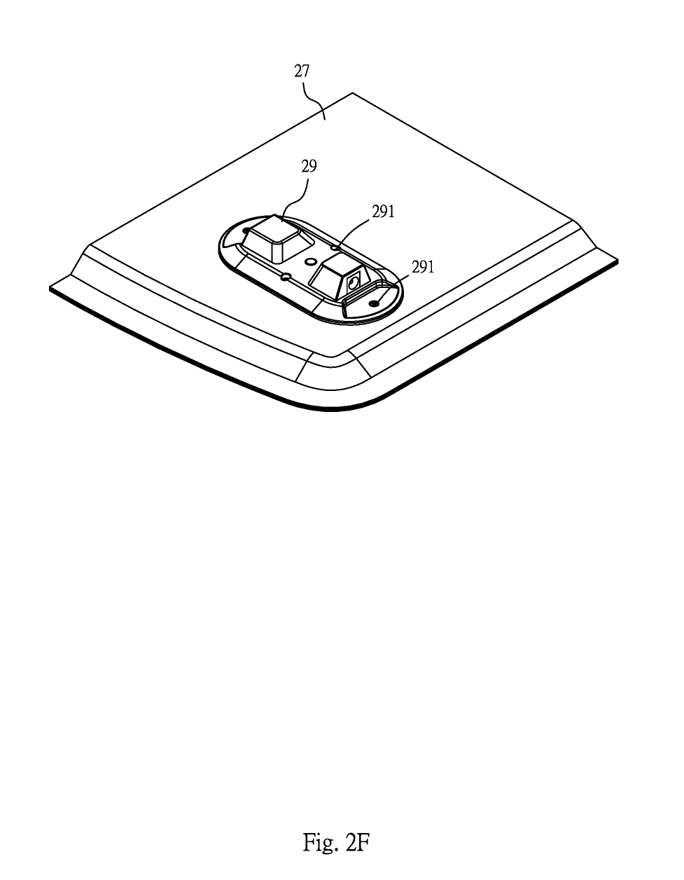

Please Refer to FIGS. 2A-2F, FIGS. 2A-2F are schematically perspective views of the assembly of the heating pad according to the present invention. As shown in FIG. 2A, the upper layer 21 of the heating pad comprises an outer layer 211 and an inner layer 212, and these layers can be assembled by a high frequency treatment. As shown in FIG. 2B, the lower cover 22 of the control box can be assembled together with the upper layer 21 of the heating pad by a high frequency treatment. As shown in FIG. 2C, the upper layer 21 of the heating pad, the foam 23, the heating plate 24 and the lower layer 25 can be assembled in order by a high frequency treatment or by other way. FIG. 2D is illustrating the succeeding assembling of the control box 26 illustrated in FIG. 2C., and the details of the control box 26 is described later. Please refer to FIG. 2E, the heating pad 27 is connected to the heating plate 24 via the wire 28 through which the current goes to make the heating plate 24 generate heat. Referring to the FIG. 2F, the upper cover 29 of the control box and the lower cover (not shown) of the control box are assembled with screw 291 and disposed on the heating pad 27 with screw 291.

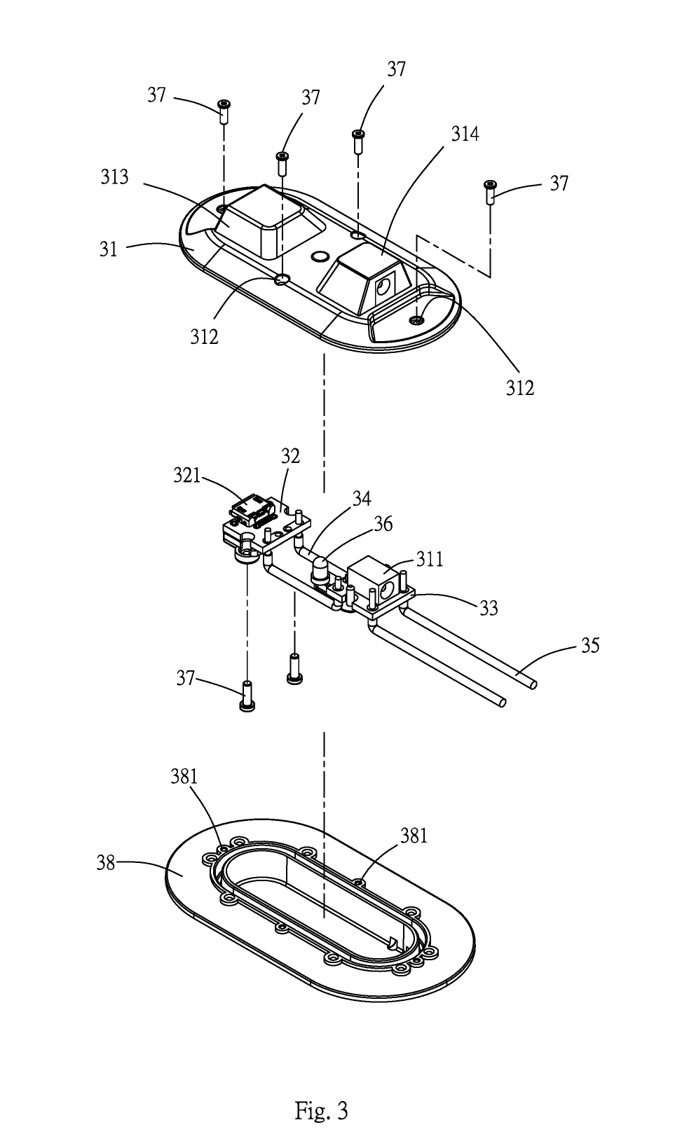

Please refer to FIG. 3, FIG. 3 is a schematically perspective view of the control box of the heating pad of the present invention. As shown in FIG. 3, the control box 03 of the heating pad of the present invention comprises an upper cover 31, a Universal Serial Bus (USB) control board 32, a Direct Current (DC) control board 33, a first cord 34, a second cord 35, a LED light source 36, a plurality of screw 37 and a lower cover 38. A Direct Current (DC) socket 311 is disposed on the upper cover 31 and is electrically connected to a power supplier. The upper cover 31 further comprises a plurality of screw hole 312 through which a plurality of screw 37 can be used to assemble the upper cover 31 with the lower cover 38. The upper cover 31 further comprises an accommodation space 313 for a Universal Serial Bus (USB) socket to accommodate a Universal Serial Bus (USB) socket 321 and an accommodation space 314 for a Direct Current (DC) socket to accommodate a Direct Current (DC) socket 311. The Universal Serial Bus (USB) control board 32 comprises the Universal Serial Bus (USB) socket 321, which is disposed in the accommodation space 313 on the upper cover 31, for electrically connecting to a Universal Serial Bus (USB) port of a computer or to a mobile power pack. The Direct Current (DC) control board 33 is electrically connected to the Direct Current (DC) socket 311, one end of the board 33 is electrically connected to the Universal Serial Bus (USB) control board 32 via the first cord 34 and another end is electrically connected to the heating plate (FIG. 1, element 15) of the heating pad of the present invention via the second cord 35. The LED light source 36 is disposed on the Direct Current (DC) control board 33 for displaying the status of current. The lower cover 38 comprises a plurality of screw hole 381 through which a plurality of screw 37 can be used to assemble the lower cover 38 and the upper cover 37.

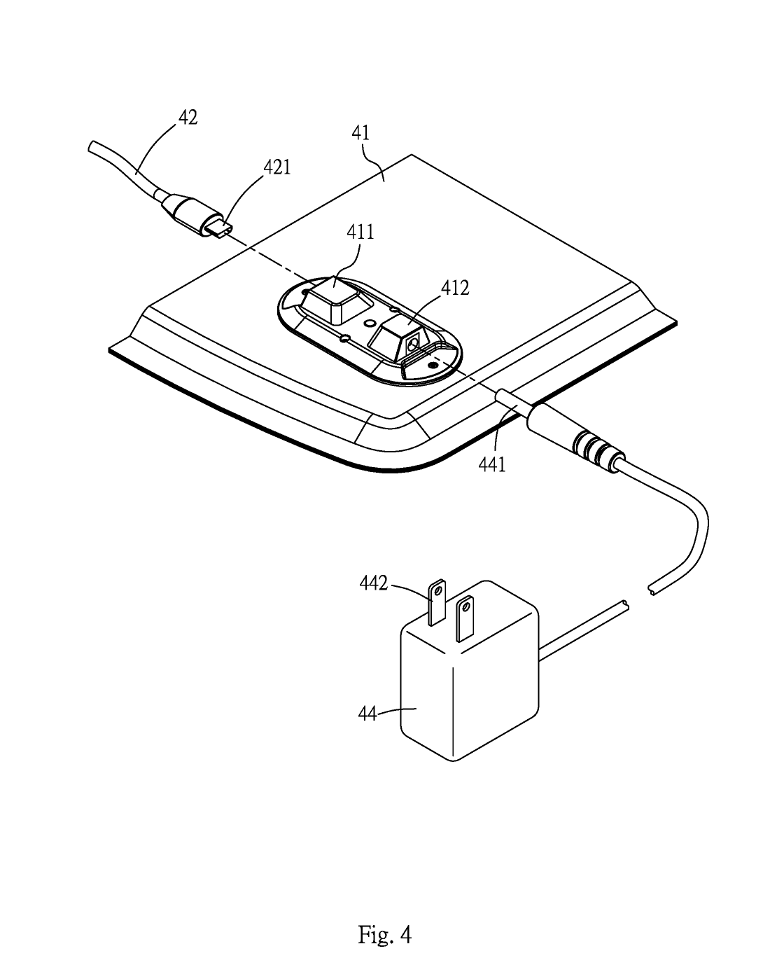

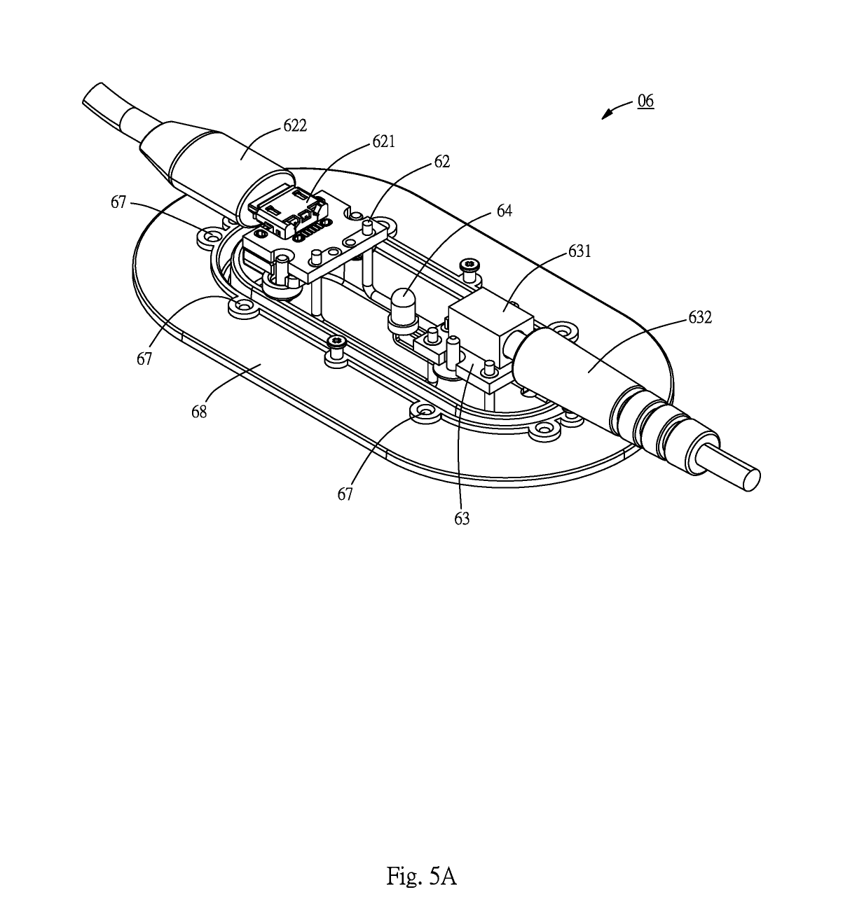

Please refer to FIG. 4, FIG. 4 is a schematically perspective view illustrating the heating pad connecting to either the power source of a Universal Serial Bus (USB) or an Alternating Current (AC). As shown in FIG. 4, when using the heating pad 41 of the present invention, the power source can be either a Universal Serial Bus (USB) one or a regular Alternating Current (AC) one. If the Universal Serial Bus (USB) one is the power source, an end 421 of a Universal Serial Bus (USB) connection cord 42 is electrically connected to the Universal Serial Bus (USB) socket 411 of the heating pad 41 of the present invention, another end of the cord 42 is electrically connected to a computer or a mobile power pack. When a regular Alternating Current (AC) is used as a power source, a Direct Current (DC) plug 441 is electrically connected to the Direct Current (DC) socket 412 of the heating pad 41, and one end of the Direct Current (DC) plug 441 is electrically connected to a AC/DC power supplier 44, and a plug 442 of which can be plugged with the Alternating Current (AC) socket, thus, the Alternating Current (AC) is converted into Direct Current (DC) to make the heating pad to generate heat.

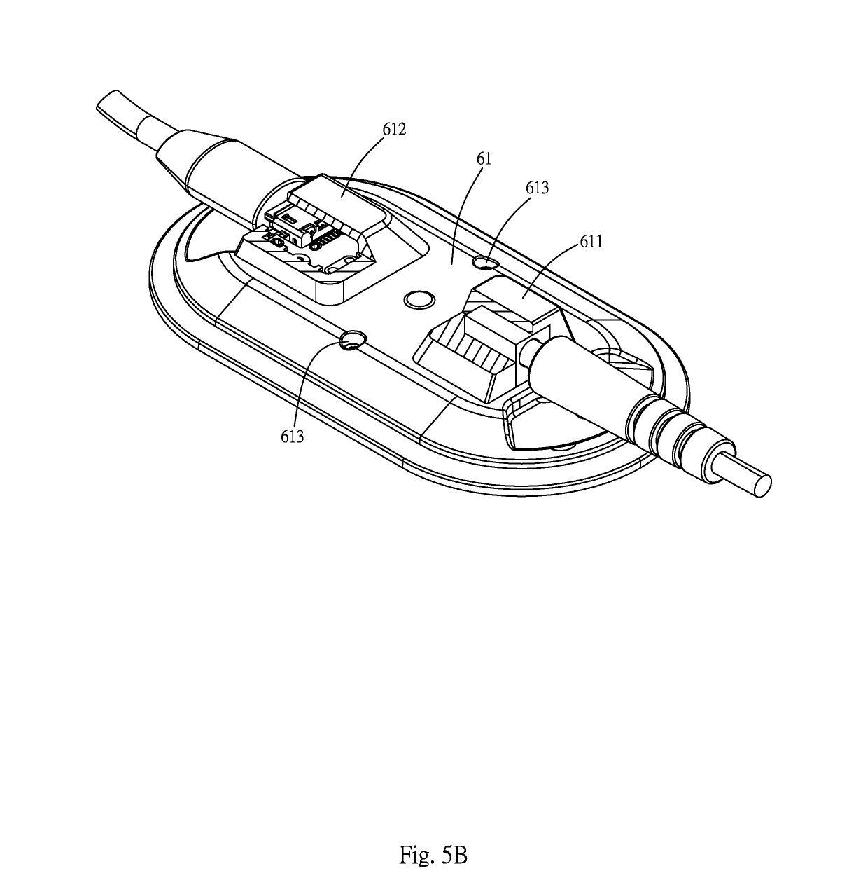

Please refer to FIGS. 5A-5B, which are schematically perspective views illustrating the assembly of an embodiment of the control box of the heating pad according to the present invention. As shown in FIGS. 5A-5B, the control box 06 of the heating pad of the present invention comprises an upper cover 61, a Universal Serial Bus (USB) control board 62, a Direct Current (DC) control board 63, a LED light source 64, a plurality of screw hole 67 and a lower cover 68. The Universal Serial Bus (USB) control board 62 comprises a Universal Serial Bus (USB) socket 621 for electrically connecting to a Universal Serial Bus (USB) plug 622. The Direct Current (DC) control board 63 comprises a Direct Current (DC) socket 631 for electrically connecting to a Direct Current (DC) plug 632. The LED light source 64 is for displaying the status of current. An accommodation space 611 (see FIG. 5B) for accommodating the Direct Current (DC) socket 631 and an accommodation space 612 (see FIG. 5B) for accommodating the Universal Serial Bus (USB) socket 621 are disposed on the upper cover 61. The upper cover 61 further comprises a plurality of screw hole 613 through which a plurality of screw can be used to assemble the upper cover 61 with the lower cover 68. The Universal Serial Bus (USB) control board 62 and the Direct Current (DC) control board 63 are electrically connected to the heating plate (FIG. 1, element 15) of the present invention, through these boards the current goes to make the plate generate heat.

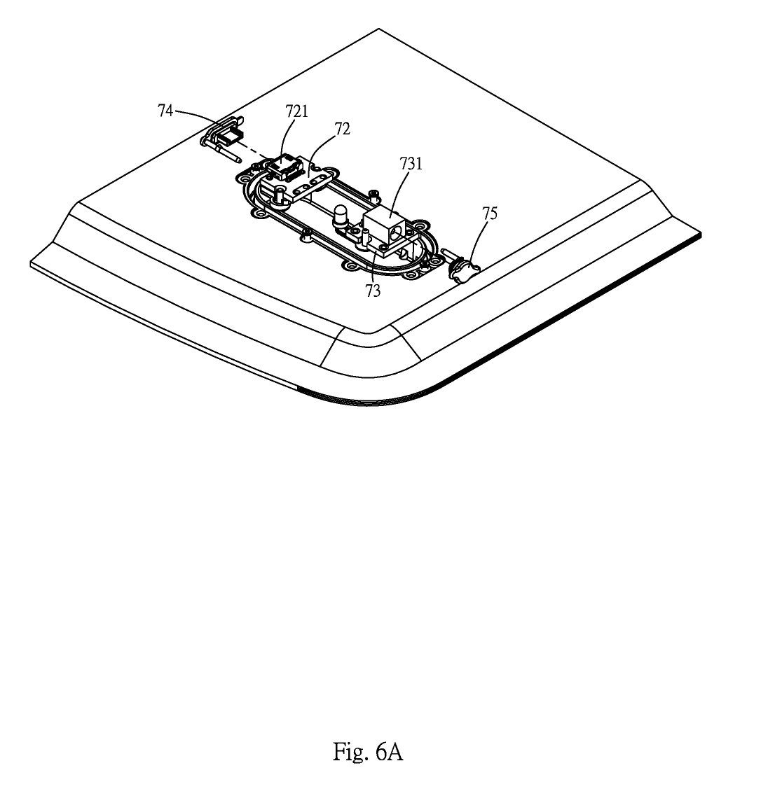

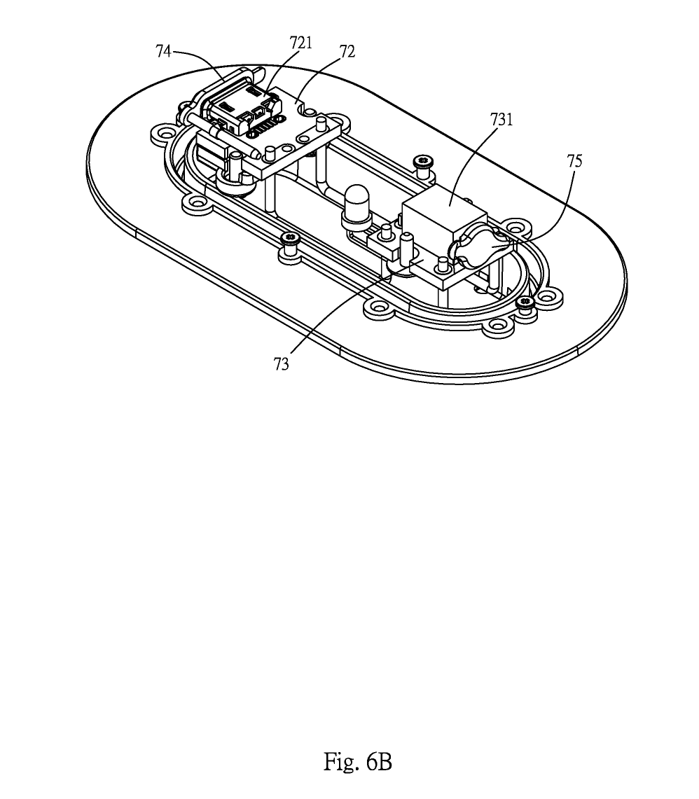

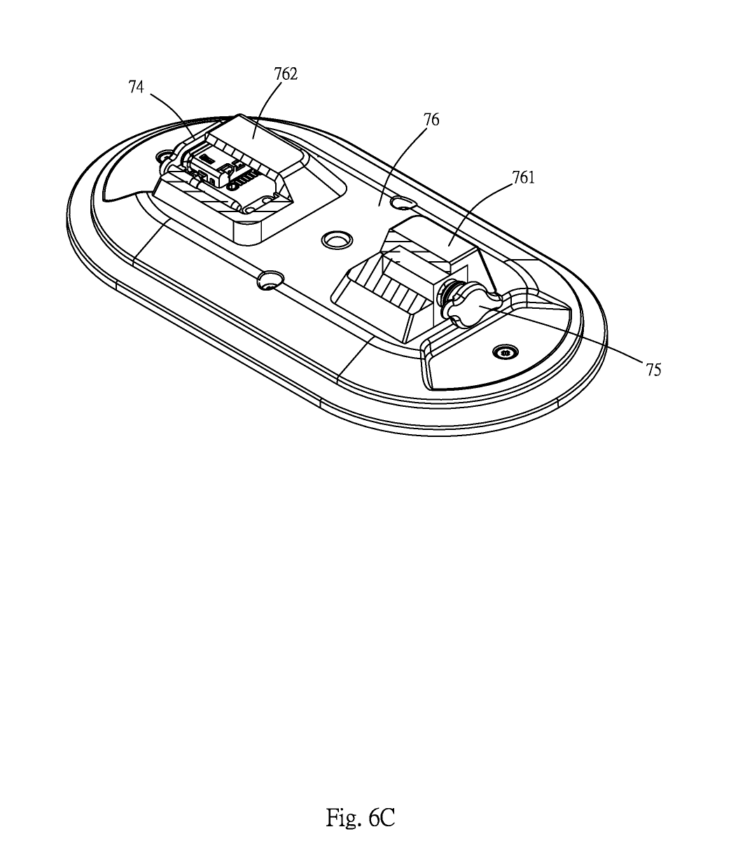

Please refer to FIGS. 6A-6B, which are schematically perspective views illustrating an dust-proof plug used with a Universal Serial Bus (USB) socket or an Direct Current (DC) socket according to the present invention. As shown, the control box of the heating pad of the present invention comprises a Universal Serial Bus (USB) control board 72 and a Direct Current (DC) control board 73. The Universal Serial Bus (USB) control board 72 further comprises a Universal Serial Bus (USB) socket 721 for connecting a Universal Serial Bus (USB) plug (not shown), and the Direct Current (DC) control board 73 further comprises a Direct Current (DC) socket 731 for connecting a Direct Current (DC) plug (not shown). When the heating pad of the present invention is not is use, to prevent dust, a Universal Serial Bus (USB) dust-proof plug 74 and a Direct Current (DC) dust-proof plug 75 are plugged into the Universal Serial Bus (USB) socket 721 and the Direct Current (DC) socket 731 respectively. As shown in FIG. 6B, the Universal Serial Bus (USB) dust-proof plug 74 and the Direct Current (DC) dust-proof plug 75 are already plugged into the Universal Serial Bus (USB) socket 721 and the Direct Current (DC) socket 731 respectively. As shown in FIG.6C, An accommodation space 761 for accommodating the Direct Current (DC) socket 731 and an accommodation space 762 for accommodating the Universal Serial Bus (USB) socket are disposed on the upper cover 76. When the heating pad of the present is not in use, to prevent dust, a Universal Serial Bus (USB) dust-proof plug 74 and a Direct Current (DC) dust-proof plug 75 are plugged into the Universal Serial Bus (USB) socket and the Direct Current (DC) socket respectively.

As illustrating in above, the heating pad of the present invention is capable of adapting the power either from a Universal Serial Bus (USB) source or a Direct Current (DC) source, it is extremely convenient for a user to use the heating pad of the present invention in the occasion without a regular Alternating Current (AC) power source, as in a preferred embodiment, a mobile power pack with USB socket can also provide the power for the heating pad. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

I claim:

1. a heating pad, comprising:
a control box;
a upper layer comprising an outer layer and an inner layer;
a foam;
a heating plate; and
a lower layer;
wherein, a upper cover of the control box is disposed on one side of the upper layer, a lower cover of the control box is disposed on another side of the upper layer, openings are disposed on the outer layer and the inner layer for accommodating the control box, an opening is disposed on the foam for accommodating the lower cover of the control box.

2. The heating pad according to claim 1, wherein the heating plate comprises a plurality of heating unit which can be chip-resistors that generates constant heat, a plurality of chip-resistor can be welded together on a copper plate and the connection of each chip-resistor can be a combination of series and parallel way, so that, the chip-resistors assure the heating function of the heating pad when partial chip-resistors are broken, the copper plate is capable of spreading the heat all over the whole heating pad and is working as not only an electrical circuit but also a thermal conductor.

3. The heating pad according to claim 1, wherein the upper layer and lower layer can be made of water-proof material.

4. The heating pad according to claim 1, wherein the upper layer and lower layer can be assembled by a high frequency treatment.

5. The heating pad according to claim 1, wherein the control box comprising:
an upper cover comprising an accommodating space for a Direct Current (DC) socket; an accommodating space for Universal Serial Bus (USB); a plurality of screw hole through which a plurality of screw can be used to assemble the upper cover and a lower cover;
a Universal Serial Bus (USB) control board comprising a Universal Serial Bus (USB) socket for electrical connecting to a Universal Serial Bus (USB) port of a computer or to a Universal Serial Bus (USB) port of a mobile power pack;
a Direct Current (DC) control board comprising Direct Current (DC) socket, one end of the Direct Current (DC) control board is electrically connecting to the Universal Serial Bus (USB) control board via a first cord, another end is electrically connecting to the heating plate via a second cord;
a LED light source being disposed on the Direct Current (DC) control board for displaying a status of current;
the lower cover; and
the plurality of screw for assembling the upper cover and the lower cover.

6. The heating pad according to claim 5, wherein the Universal Serial Bus (USB) control board is a flexible printed circuit board (FPCB).

7. The heating pad according to claim 5, wherein the Direct Current (DC) control board is a flexible printed circuit board (FPCB).

8. The heating pad according to claim 5, wherein a Universal Serial Bus (USB) dust-proof plug and a Direct Current (DC) dust-proof plug can be plugged into the Universal Serial Bus (USB) socket and the Direct Current (DC) socket respectively.
